(19) United States
(12) Patent Application Publication
(10) Pub. No.: US 2019/0347861 A1
(43) Pub. Date: Nov. 14, 2019

(54) APPARATUS FOR PRESENTING AUGMENTED REALITY

(71) Applicant: Benjamin Hesson, Lehi, UT (US)

(72) Inventor: Benjamin Hesson, Lehi, UT (US)

(21) Appl. No.: 16/408,228

(22) Filed: May 9, 2019

Related U.S. Application Data
(60) Provisional application No. 62/669,966, filed on May 10, 2018.

(51) Int. Cl. G06T 19/00; G06T 7/73; G06F 3/0484; G06F 3/0481

(52) U.S. Cl. CPC G06T 19/006; G06T 7/73; G06T 2207/10016; G06F 3/04815; G06T 2219/024; G06F 3/04845

(57) ABSTRACT

An apparatus for presenting augmented reality includes a camera, a processor, communicatively connected to the camera, a display, communicatively connected to the processor, for displaying images from the camera, and a non-transitory storage medium. The non-transitory storage medium includes a device identify module, the device identify module identifying a token representing the apparatus for presenting augmented reality, an overlay receive module, the overlay receive module receiving, from an image overlay server, an overlay image, an image receive module, the image receive module receiving, from the device camera, a reality image, a presentation image create module, the presentation image create module creating, based on the overlay image and the reality image, a presentation image; and a display module, displaying the presentation image on the display.

### TECHNICAL FIELD

The disclosure relates generally to apparatus for presenting augmented reality. Specifically, the disclosure relates to an apparatus for presenting a mixture of reality and supplemental reality.

### BACKGROUND

Augmented reality comprises a combination of images to create a vision of reality that creates a virtual world. Augmented reality may use significant bandwidth to stream multiple images, and the images may be passed multiple times.

The mixture of virtual and physical reality presents opportunities for new interactions, including games and communication. Games may present images in combination with live images to create a unique interaction experience. Communication may allow faces, masks, costumes, or effects to entertain and to enhance communication.

### BRIEF SUMMARY

An apparatus for presenting augmented reality is described. The apparatus includes a camera, a processor, a display, and a non-transitory storage medium. The processor is communicatively connected to the camera. The display is communicatively connected to the processor to display images from the camera. The non-transitory storage medium stores a number of modules. The modules include a device identify module to identify a token representing the apparatus for presenting augmented reality. The modules include an overlay receive module to receive, from the image overlay server, an overlay image. The modules include an image receive module to receive from the device camera, a reality image. The modules include a presentation image create module to create, based on the overlay image and the reality image, a presentation image. The modules include a display module to display the presentation image on the display.

A system for creating an augmented reality image is described. The system includes a processor, a network interface connector, and a non-transitory storage medium. The network interface connector is communicatively connected to the processor. The non-transitory storage medium is communicatively connected to the processors and includes a number of modules. The non-transitory storage medium includes a receive module, a customization module, a device identify module, and an overlay transmit module. The receive module receives, from a first user device, a number of images. The customization module receives customization from a first user device to provide customization data for an overlay image. The overlay create module creates an image overlay. The device identify module identifies a second user device. The overlay transmit module transmits an overlay image to the second user device. The second user device is an apparatus for presenting augmented reality.

A method for presenting augmented reality using an apparatus for presenting augmented reality is described. The method includes a number of steps. The method includes identifying a token representing the apparatus for presenting augmented reality. The method includes receiving, from the image overlay server, overlay image data. The method includes receiving, from the device camera, a reality image. The method includes identifying, in the reality image, a number of reference points, the reference points informing the presentation of a presentation image. The method includes creating, based on the overlay image data, the number of reference points, and the reality image, a presentation image. The method includes displaying the presentation image on the display.

### BRIEF DESCRIPTION OF THE DRAWINGS

A more particular description of the invention briefly described above is made below by reference to specific example. Several examples are depicted in drawings included with this application. An example is presented to illustrate, but not restrict, the invention.

FIG. 1 illustrates a system including an apparatus for presenting augmented reality.

FIG. 2 illustrates a system including an apparatus for presenting augmented reality.

FIG. 3 illustrates a system including an apparatus for presenting augmented reality using a number of images.

FIG. 4 illustrates a system including an apparatus for presenting augmented reality using a number of images.

FIG. 5 illustrates an apparatus for presenting augmented reality.

FIG. 6 illustrates a system for creating augmented reality.

FIG. 7A illustrates an overlay image created from a number of images.

FIG. 7B illustrates a reality image where an augmented reality image may be presented.

FIG. 7C illustrates an augmented reality image that combines an overlay image and reality image.

FIG. 8A illustrates an image used to create an overlay image.

FIG. 8B illustrates an image used to create an overlay image.

FIG. 8C illustrates a computer graphic image used to create an overlay image.

FIG. 8D illustrates an augmented reality image combining a reality image and a number of overlay images.

FIG. 9 illustrates a method for presenting an augmented reality image.

### DETAILED DESCRIPTION

A detailed description of the claimed invention is provided below by example, with reference to examples in the appended figures. Those of skill in the art will recognize that the components and steps of the invention as described by example in the figures below could be arranged and designed in a wide variety of different configurations, without departing from the substance of the claimed invention. Thus, the detailed description of the examples in the figures is merely representative of an example of the invention, and is not intended to limit the scope of the invention as claimed.

In some instances, numerical values are used to describe features such as spreading factors, output power, bandwidths, link budgets, data rates, and distances. Though precise numbers are used, one of skill in the art recognizes that small variations in the precisely stated values do not substantially alter the function of the feature being described. In some cases, a variation of up to 50% of the stated value does not alter the function of the feature. Thus, unless otherwise stated, precisely stated values should be read as the stated number, plus or minus a standard variation common and acceptable in the art.

For purposes of this disclosure, the modules refer to a combination of hardware and program instructions to perform a designated function. Each of the modules may include a processor and memory. The program instructions are stored in the memory, and cause the processor to execute the designated function of the modules. Additionally, a smartphone app and a corresponding computer system may be used to implement a module or a combination of modules.

A purpose of the claimed apparatuses, methods, and systems is to facilitate the presentation of augmented reality. In one example, a video is recorded and a number of customizations to the video are made to create an overlay image or video. The overlay image or video is transmitted to an augmented reality apparatus to display with a reality video. In another example, a plurality of videos are combined to create an overlay video. The plurality of videos that are combined are customized to create an overlay video. The overlay video is transmitted to an augmented reality device to display with a reality video.

For purposes of this disclosure as used in the present specification and in the appended claims the term “image,” as used herein, refers to an electronic representation of a scene, object, or event.

As used in the present specification and in the appended claims, the term video refers to a collection of data representing a number of images that when displayed sequentially appear to be representing motion of an object or subject.

As used in the present specification and in the appended claims, the term 3-D refers to a digital representation of a subject to be displayed as if the subject existed in three dimensions.

As used in the present specification and in the appended claims, the term reality refers to a real-time or near real-time representation of a subject in close proximity of time to when the subject is actually viewable.

As used in the present specification and in the appended claims, the term augmented reality refers to a combination of a reality image or video that is combined with an image or video that is created at a different location or with a different camera. Augmented reality may be created by combining a computer-generated image with a reality image.

As used in the present specification and in the appended claims, the term a number refers to one or more of an item; zero not being a number, but rather, the absence of a number.

As used in the present specification and in the appended claims, the term a plurality refers to two or more of an item.

As used in the present specification and in the appended, the term communication refers to the imparting or exchange of information.

As described above, augmented reality allows for the combination of one image with a reality image. Augmented reality creates what appears to be a version of reality that is desirable but has not existed or does not currently exist. Augmented reality may allow for alternative presentations of information. Often augmented reality has limited use due to the expense and difficulty in creating images to be used for augmentation of a reality image or video.

Augmented reality may be restricted in use because an augmented reality video is recorded and stored on a server. A reality video is then recorded and streamed to the server. The server then combines the augmented reality video and the real-time video to create an augmented real-time video. The augmented real-time video is then transmitted to a user device for display. The multiple transmissions restrict who and when augmented reality may be displayed.

Additionally, augmented reality videos may require a user to create an account to gain access to an augmented reality video. Processes a user is required to complete deter users from using and creating augmented reality experiences.

A Bluetooth communication distributor may allow a number of originating devices to communicate with a plurality of client devices. The Bluetooth communication distributor may allow for larger video screens, more speakers in an audio system, or a greater variety of client devices. A Bluetooth communication distributor may allow a number of originating devices to share a number of client devices, such as a number of speakers. A Bluetooth communication distributor may simplify and expand the usage of originating devices in some systems. The Bluetooth communication distributor may reduce updating software or hardware on an originating device or the client devices.

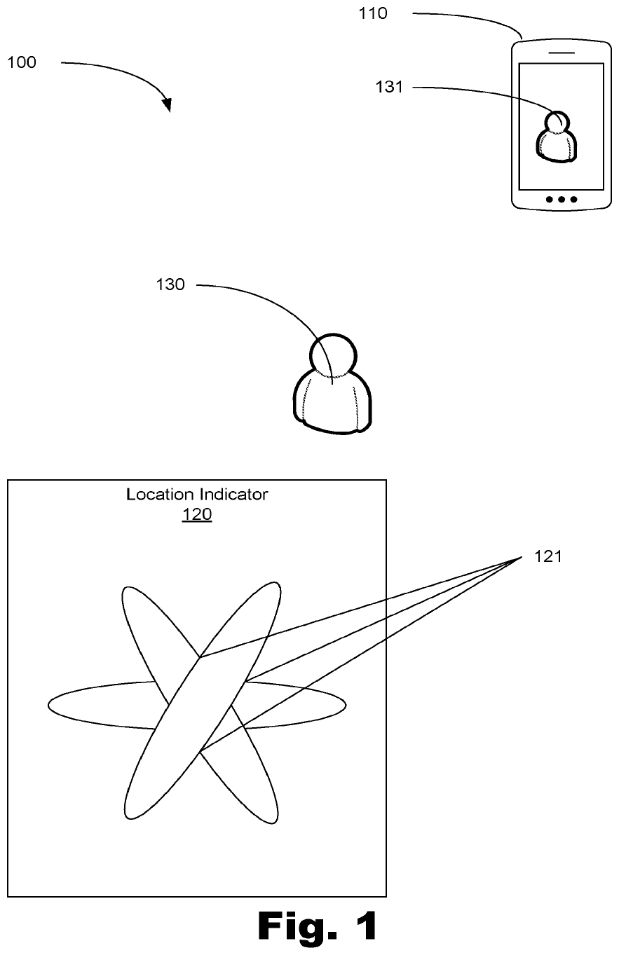

Referring now to the figures, FIG. 1 illustrates an augmented reality system (100) including an apparatus (110) for presenting augmented reality. The apparatus (110) uses a location indicator (120) to identify words present an augmented reality image in relation to the location indicator (120). The location indicator (120) may include a number of location points (121). The number of location points (121) are used by the apparatus (110) for presenting augmented reality to determine the location of the apparatus.

The apparatus (110) for presenting augmented reality then displays an overlay image (131) on a screen that is also showing a reality image. The image (131) on the screen causes the reality image to appear as though an augmented reality image (130) is appearing in proximity to the location indicator (120). The image that appears on the apparatus (110) for presenting augmented reality creates an illusion that the augmented reality image (130) is the reality image. This allows for special effects to reality, such as a presentation of the video combined with a reality image.

The location indicator (120) provides an anchor or starting point for the presentation of augmented reality. The anchor image (120) maybe a designer pattern of decorative value. The anchor image (120) may be a geometric shape providing line intersections for the augmented reality apparatus (110). The anchor image (120) may be an image that is known, were points of the image can be recognized. The anchor image (120) may be a computer information image such as a QR code. The anchor image (120) may communicate data to the augmented reality apparatus (110).

The apparatus (100) for presenting augmented reality makes it appear as though an object or a person is present in reality.

Previously, such augmented reality was restricted to science fiction movies. Characters appeared to be projected into reality by some form of hologram or display. In reality, such projections require numerous cameras, lights, projectors, and other equipment to create holographic images. The apparatus (100) for presenting augmented reality simulates this experience using hardware that may be readily available.

An overall example of the principles described herein will be given using FIG. 1. A first user using a first user device creates an overlay image using an augmented reality creation system. A second user using an augmented reality apparatus (110) then uses the overlay image. The augmented reality apparatus (110) communicates with the augmented reality creation system and identifies itself as an augmented reality apparatus (110). The augmented reality creation system verifies that the augmented reality apparatus (110) may view the image overlay (131). The image overlay (131) is then transmitted to the augmented reality apparatus (110). The second user using the augmented reality apparatus (110) points a camera associated with the augmented reality apparatus (110) at a location indicator (120). The augmented reality apparatus (110) identifies a number of location points (121) in the location indicator (120). The augmented reality apparatus (110) identifies the location of the augmented reality apparatus in relation to the location indicator (120) based on the location points (121).

The augmented reality apparatus (110) creates a real-time video or image using the camera of the location indicator. The augmented reality apparatus (110) calculates where to place the overlay image in the real-time video or image based on the location points (121). The overlay image is then combined with the real-time video to create the appearance that images in the overlay image are present in the real-time video. The augmented reality apparatus (110) may update the placement of the overlay image is the augmented reality apparatus changes location in relation to the location points (121) in the location indicator (120).

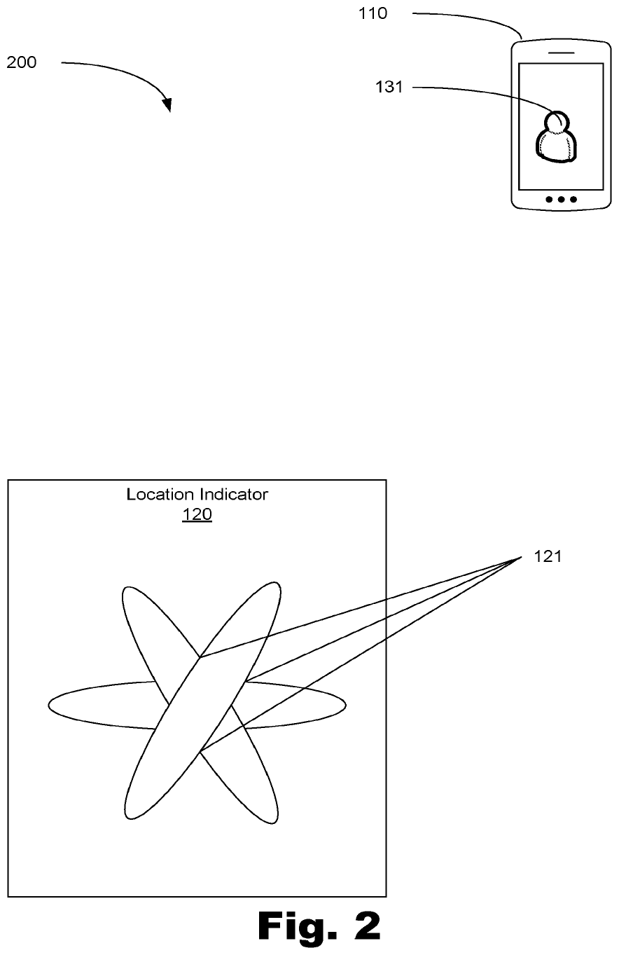

FIG. 2 illustrates an augmented reality system (200) including an apparatus (110) for presenting augmented reality. The overlay image (131) appears only on the display of the augmented reality apparatus (110). The overlay image (131) is not projected from the augmented reality apparatus.

The overlay image (131) is combined with the reality image and presented based on the location points (121) in the location indicator (120).

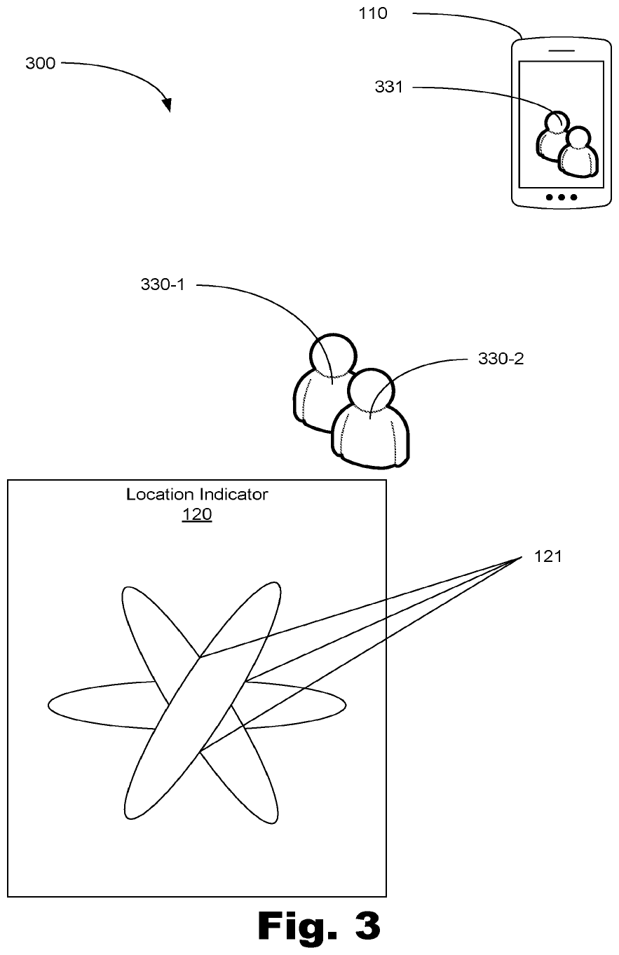

FIG. 3 illustrates an augmented reality system (300) that includes a plurality of overlay images. The first overlay image (330-1) is uploaded to an augmented reality creation system. A second overlay image (330-2) is also uploaded to an augmented reality creation system. The augmented reality creation system combines the first overlay image (330-1) and the second overlay image (330-2) to create an overlay image that is transmitted to the augmented reality apparatus (110). The augmented reality apparatus (110) combines the overlay image (331) with the reality image of the location indicator (120) as previously described in FIG. 1.

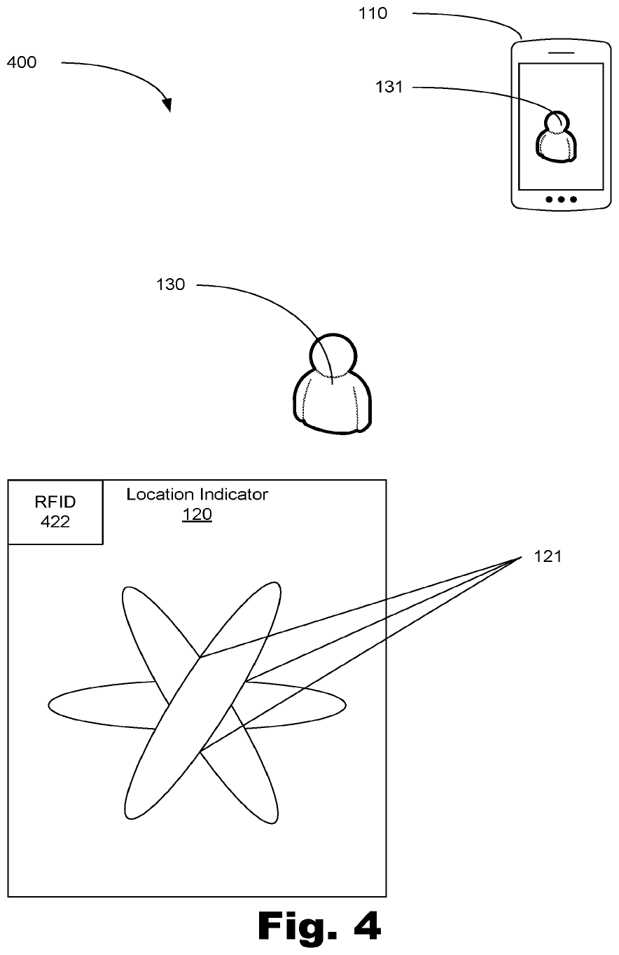

FIG. 4 illustrates an augmented reality system (400) that includes a radiofrequency identification system. The location indicator (120) includes a radiofrequency identifier or RFID (422). The RFID (422) uses radio frequency to communicate with the augmented reality apparatus (110). The RFID (422) may identify a particular location indicator with greater detail than the image. The RFID (422) may serve as a location point (121) within the location indicator (120). The location indicator (120) may include a number of RFID's (422). The RFID (422) may be activated by responding to a radio frequency emitted from the augmented reality apparatus (110). The RFID (422) may create a radio frequency by responding to the radio frequency sent by the augmented reality apparatus (110) using resonance to generate the response frequency. The RFID (422) may have a power source to generate a radio frequency.

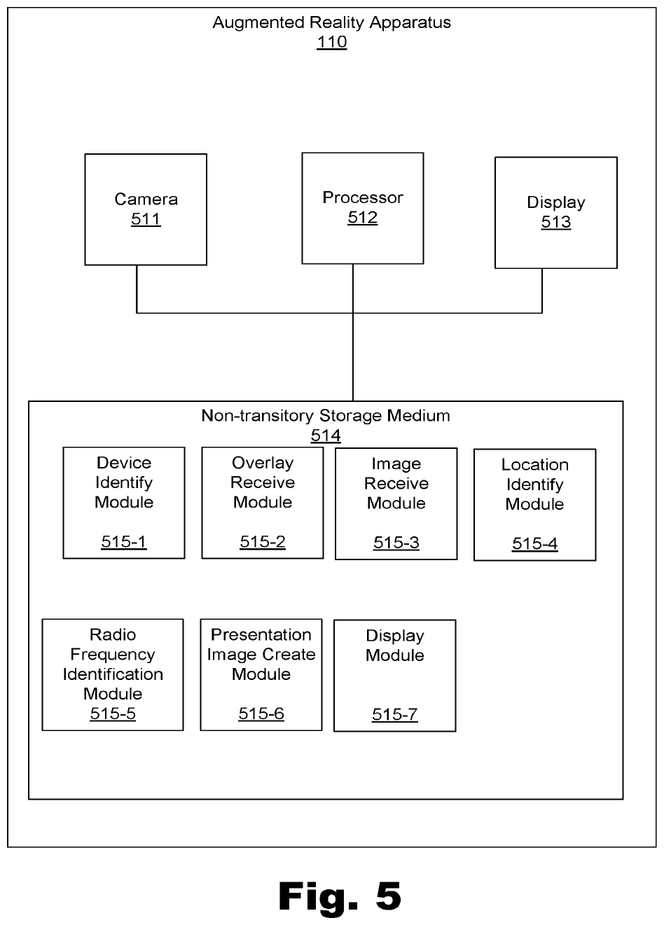

FIG. 5 represents an illustration of an augmented reality apparatus (110). The augmented reality apparatus (110) includes a camera (511), a processor (512) a display (513), and a non-transitory storage medium (514) that are communicatively connected.

As illustrated, the non-transitory storage medium (514) includes a device identity module (515-1), an overlay receive module (515-2), an image receive module (515-3), a location identify module (515-4), a radiofrequency identification module (515-6), and a display module (515-7).

The device identify module (515-1) identifies the augmented reality apparatus (110) to an augmented reality creation system. The device identify module (515-1) identifies a token that represents the augmented reality apparatus (110). This token may be based on hardware attributes of the augmented reality apparatus such as the media access control address (MAC address), the Internet protocol address (IP address), a serial number associated with the processor, or other identifiers of the device and/or a user of the device. The token is communicated to an augmented reality creation system to control access to an image overlay.

The overlay receive module (515-2) receives, from an augmented reality creation system, and image overlay. The augmented reality creation system may be an image overlay server. The augmented reality creation system may restrict access to the image overlay based on the identity of the augmented reality apparatus (110). The image overlay image may comprise data to create a three-dimensional rendering of the overlay image.

The image receive module (515-3) receives, from the camera (511) a reality image. The reality image may be a number of images or data that are used to create an image. A number of images may be displayed sequentially to create a reality video. The reality image is received on the augmented reality device (110) by the camera (511), and may remain on the augmented reality device without being transmitted to an augmented reality creation system.

The location identification module (515-4) calculates the location of the augmented red reality apparatus in relation to a number of points in the reality image. The location identification module (515-4) identifies a number of points in the reality image. The points may be intersections of lines, points of the pattern, radio frequency identification information, or other information that provides multiple points of reference within the reality image of a location indicator.

The radiofrequency identification module (515-5) receives radio frequency information identifying the location indicator and informing the augmented reality apparatus of information regarding an overlay image to be requested. The radio frequency identification information may inform the augmented reality apparatus (110) of information to receive an image overlay.

The presentation image create module (515-6) creates, based on the overlay image and the reality image, a presentation image. The presentation image create module (515-6) may superimpose the overlay image on the reality image. The presentation image create module (515-6) may use other algorithms to combine the overlay image and the reality image. The presentation image create module (515-6) may include the location of the augmented reality apparatus (110) in respect to the location indicator.

The display module (515-7) displays the presentation image on the display (513). The display module (515-7) gives the user of the augmented reality apparatus (110) the appearance that the subject of the overlay image is present in reality as viewed through the augmented reality apparatus (110).

An overall example will now be given according to FIG. 5.

The device identify module (515-1) identifies a device based on a media access control address associated with a network interface on the augmented reality device, and creates a pseudo-unique identifier. The pseudo-unique identifier is transmitted to an augmented reality creation system. The device identify module (515-1) confirms with the augmented reality creation system that the augmented reality apparatus (110) has permission to access the overlay image.

The overlay image receive module (515-2) receives an image and data to be combined with a reality image. In this example, the image data received includes information to create a three-dimensional rendering of the overlay image.

The image receive module (515-3) receives a reality image from the camera (511) of a location indicator (FIG. 1, 120).

The location identification module (515-4) identifies the location of the augmented reality apparatus (110). The location of the augmented reality apparatus (110) is used in combination with the image data to calculate the presentation of the three-dimensional object for the augmented reality apparatus (110) in relation to the location identification (FIG. 1, 120).

The radiofrequency identification module (515-5) receives radio frequency information, which is used to identify the location indicator (FIG. 1, 120) and inform access permission to the overlay image.

The presentation image create module (515-6) creates a presentation image using the overlay image, the reality image, and the location of the augmented reality apparatus (110). The location of the augmented reality apparatus (110) is used to perform operations on the overlay image, based on the location of the apparatus, to determine the representation in the reality image that makes the overlay image appear to be three-dimensional. Such calculations may include the display of different data and/or shadowing effects to appear as though the images three-dimensional.

The display module (515-7) displays the presentation image on the display (513) for the user of the augmented reality apparatus (110).

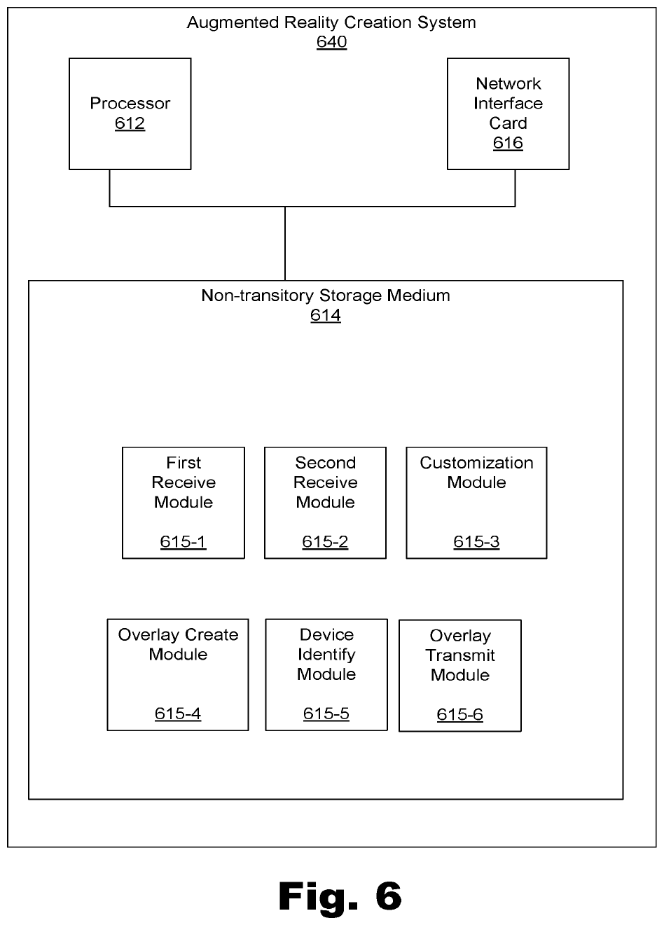

FIG. 6 represents an augmented reality creation system (640). The augmented reality creation system (640) may be used by an augmented reality apparatus (FIG. 1, 110) to create and store a number of overlay images to be used by the augmented reality apparatus. The augmented reality creation system (640) in this example includes a processor (612), a network interface card (616), and a non-transitory storage medium (614).

The non-transitory storage medium (614) includes a number of modules. Each module causes the augmented reality creation system (640) to perform a particular task. Each module may comprise a combination of hardware, software, and processors to cause the augmented reality creation system to perform the task. In this example each module causes the processor (612) to execute a number of instructions to cause the augmented reality creation system (640) to perform a task.

The non-transitory storage medium includes a first receive module (615-1), a second receive module (615-2), a customization module (615-3), an overlay create module (615-4), a device identify module (615-5), and an overlay transmit module (615-6).

The first receive module (615-1) receives, from a first user device, a number of images. The images represent images the first user may use in the creation of an overlay image.

The second receive module (615-2) receives, from a second user device, a number of images. The images represent images the first user or the second user may use in the creation of an overlay image.

The customization module (615-3) allows a first user to customize the overlay image. The first user may make modifications to images received by the first receive module (615-1) or the second receive module (615-2). The customization module (615-3) may include a theme. The theme may include a number of images that may be used in creating the overlay image. The theme may include a number of computer graphics to add to the overlay image. The theme may include relative locations of uploaded images as well as computer graphics.

The overlay create module (615-4) creates an overlay image based on a combination of images received by the first receive module (615-1), the second receive module (615-2), and the customization module (615-3). The overlay image may include data indicating that a portion of the overlay image is transparent. The overlay image may include data necessary to allow the augmented reality apparatus (FIG. 1, 110) to create a three-dimensional rendering of the subject of the overlay image.

The device identify module (615-5) identifies an augmented reality apparatus, the augmented reality apparatus is used for presenting augmented reality. The device identify module (615-5) may use information received from an augmented reality apparatus (FIG. 1, 110) to identify and control access to an image overlay. The device identify module (615-5) may restrict access to an overlay image. Access to an overlay image may be restricted based on the device identity or the number of times the device has accessed the overlay image.

The device identify module (615-5) identifies a specified number of devices to be identified. The specified number of devices limits the number of devices that may view the overlay image. In one example, the device identify module (615-5). In one example, the device identify module (615-5) allows a single device to receive the overlay image and view the augmented reality experience. In another example, the device identify module (615-5) allows three devices to receive the overlay image and view the augmented reality experience.

The overlay image transmit module (615-6) transmits the overlay image to the augmented reality apparatus (FIG. 1, 110). The overlay image transmit module (615-6) may transmit the overlay image only when permission is granted.

The overlay transmit module (615-6) transmits the overlay image a specified number of times. The specified number of times limiting the number of times the overlay image may be viewed. In one example, the overlay transmit module (615-6) transmits the overlay image once. In another example, the overlay transmit module (615-6) transmits the overlay image six times.

Overall example according to FIG. 6 will now be described. The augmented reality creation system (640) receives, using the first receive module (615-1) from a first user device a first video image. The first video image represents a first user singing a song.

The augmented reality creation system (640) receives a second video image using the second receive module (615-2). The second video image represents a second user singing the same song.

The customization module (615-3) receives commands from the first user and second user to combine the first video and the second video to create an overlay video that appears to show the first user and the second user singing the song together. The customization module (615-3) receives identification of a number computer graphics to be added to the overlay video to enhance the viewability and enjoyment of the overlay video.

The overlay create module (615-4) creates the overlay video based on the combination of the first video, the second video, and the computer graphics to be added. The overlay create module (615-4) may compress or alter data to enhance the transmission to an augmented reality device (FIG. 1, 110).

The device identify module (615-5) identifies the augmented reality apparatus (FIG. 1, 110) and confirms that the augmented reality apparatus is permitted to use the image overlay.

The overlay transmit module (615-6) transmits the overlay image to the augmented reality apparatus (FIG. 1, 110).

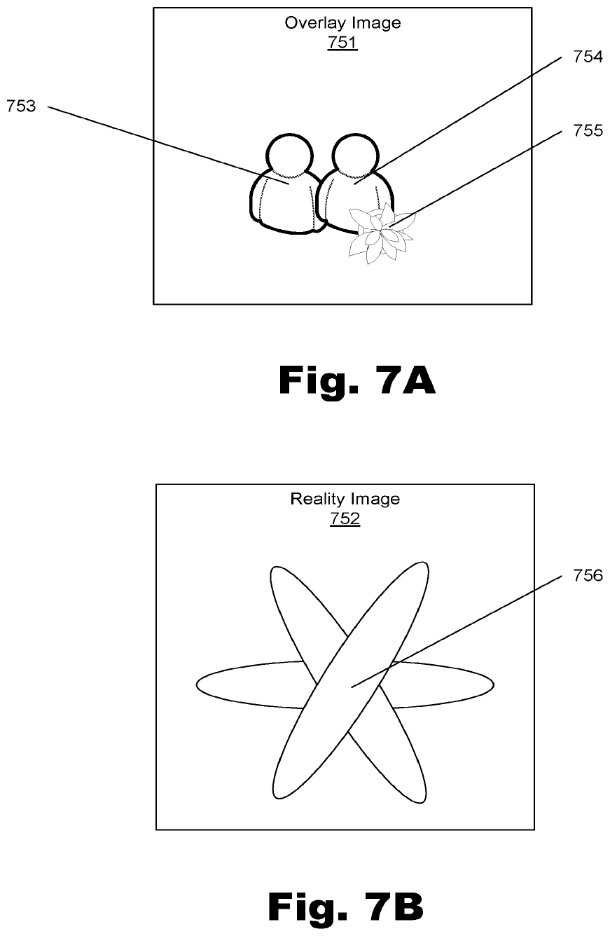

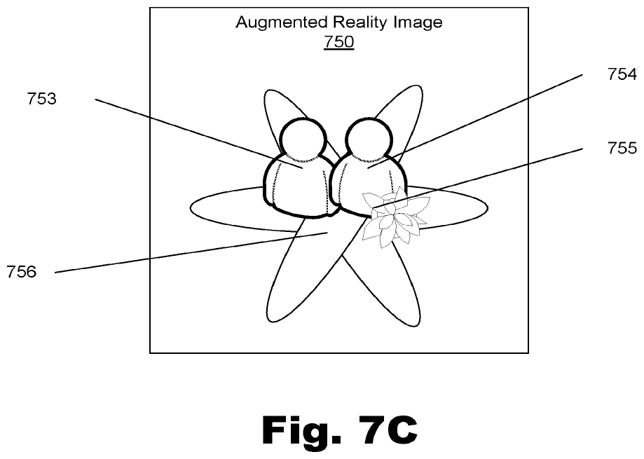

FIGS. 7A-C represent a series of figures for the creation of an augmented reality image.

FIG. 7A represents an overlay image (751). The overlay image (751) includes a first subject (753), a second subject (754), and a computer graphic (755). The overlay image (751) is transmitted to an augmented reality apparatus (FIG. 1, 110).

FIG. 7B represents a reality image (752). The reality image (752) represents an image received by the camera (FIG. 5, 511) associated with the augmented reality apparatus (FIG. 1, 110). The reality image includes a location indicator (FIG. 1, 120).

FIG. 7C represents an augmented reality image (750). The augmented reality image (750) includes a location identifier (756) from the reality image (FIG. 7B, 752) and the overlay image, (FIG. 7A, 751) including the first subject (753), the second subject (754) and the computer graphic (754). By overlaying the overlay image (FIG. 7A, 751) and the reality image (FIG. 7B, 752) it appears through the augmented reality apparatus (FIG. 1, 110) that the first subject (753), the second subject (754) and the computer graphic (754) are present in the reality image (FIG. 7B, 752).

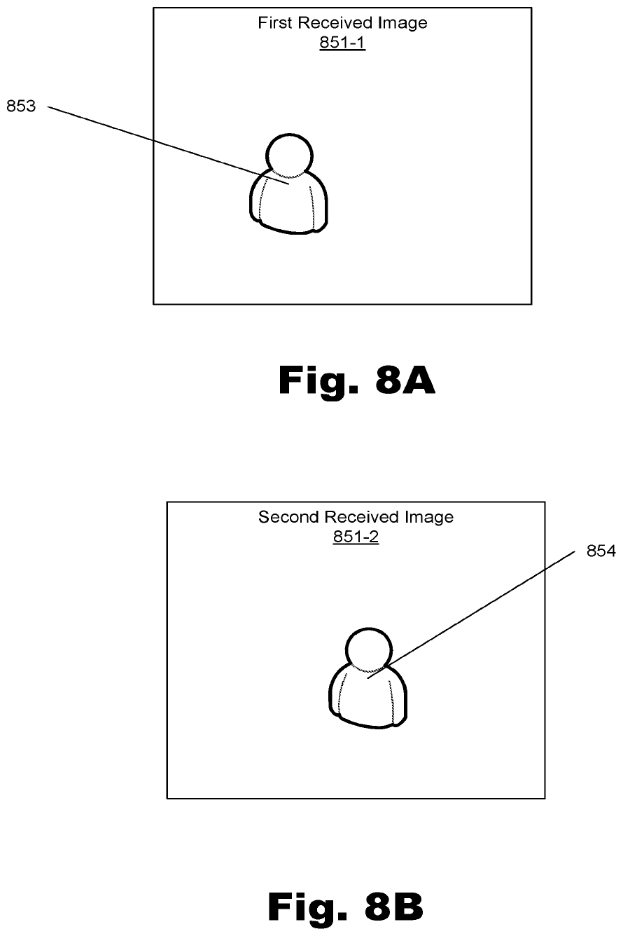

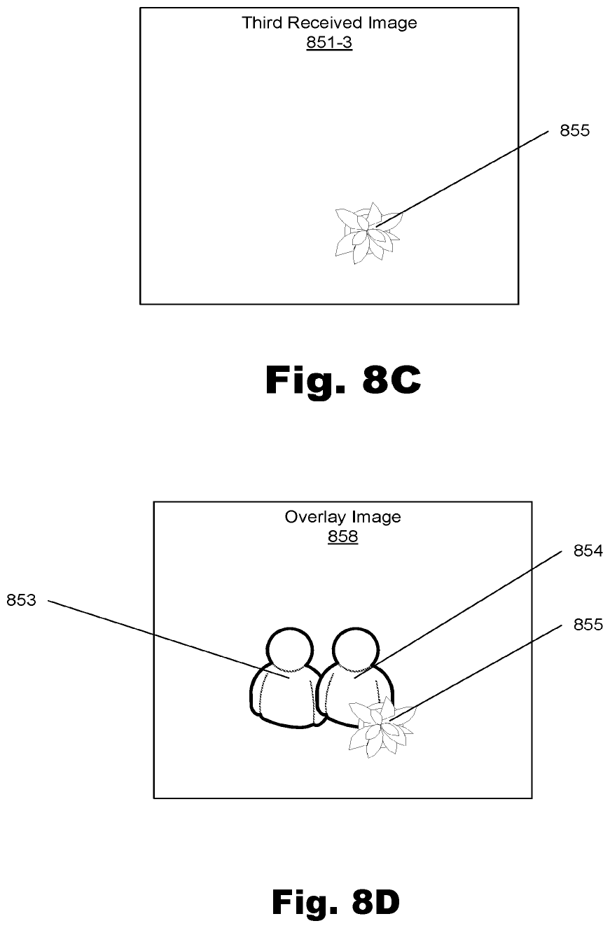

FIGS. 8A-D represent the creation of an overlay image that receives and combines a number of images from different sources. FIGS. 8A-D represent receiving a plurality of images. The images may be received from a single system user or from a number of system users. The principles illustrated in FIGS. 8A-D could be expanded to including any number of images from any number of users.

FIG. 8A represents a first received image (851-1) of a first subject (853) as received by a system for creating an augmented reality image (FIG. 6, 640). FIG. 8B represents a second received image (851-1) of a second subject (854) as received by a system for creating an augmented reality image (FIG. 6, 640). FIG. 8C represents a third received image (851-3) of a third subject (855). The third subject (855) is a computer graphic to be added to the overlay image.

FIG. 8D represents an overlay image (858). The overlay image is created by the system for creating an augmented reality image (FIG. 6, 640). The overlay image (858) is created by combining the first image (FIG. 8A, 851-1), the second image (FIG. 8B, 851-2), and the third image (FIG. 8C, 851-3) to create the overlay image that includes the first subject (853), the second subject (854), and the third subject (855).

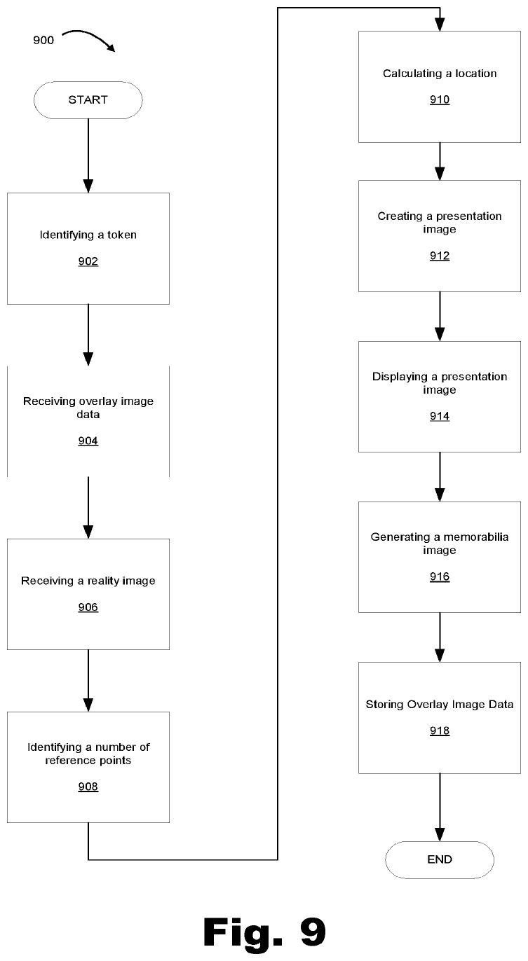

FIG. 9 illustrates a method (900) for presenting augmented reality using an augmented reality apparatus. The method includes identifying (902) a token representing the apparatus for presenting augmented reality, receiving (904) from an image overlay server, an overlay image, receiving (906), from a camera associated with the augmented reality apparatus, a reality image, identifying (908), in the reality image, a number of reference points, calculating (910) based on the number reference points, a location for the augmented reality apparatus to present an overlay image, creating (912) a presentation image, displaying (914) the presentation image on a display, generating (916) a number of memorabilia images, and storing (918) overlay image data.

Identifying (902) a token representing the apparatus for presenting augmented reality. The token may be constructed using a media access control address, and Internet protocol address, or a device serial number

Receiving (904) from an image overlay server, an overlay image. The overlay image may comprise overlay image data. The overlay image data may represent a three dimensional subject.

Receiving (906), from a camera associated with the augmented reality apparatus, a reality image. The reality image representing a view of a location indicator.

Identifying (908), in the reality image, a number of reference points. The number of reference points provides a reference for displaying an overlay image.

Calculating (910) based on the number reference points, a location for the augmented reality apparatus to present an overlay image.

Creating (912) a presentation image. Creating the presentation may include calculating information for presentation of a three dimensional image.

Displaying (914) the presentation image on a display associated with the augmented reality apparatus.

Generating (916) a number of memorabilia images, and storing (918) overlay image data. The memorabilia image may allow a use to preserve portions of the presentation image as a souvenir of the presentation image.

Storing (918) overlay image data on a non-transitory storage device. The stored overall image data may allow for a repeat of the presentation by the user at an alternative time.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

1. An apparatus for presenting augmented reality, the apparatus comprising:
a camera;
a processor, communicatively connected to the camera;
a display, communicatively connected to the processor, for displaying images from the camera; and
a non-transitory storage medium, the non-transitory storage medium comprising:
a device identify module, the device identify module identifying a token representing the apparatus for presenting augmented reality;
an overlay receive module, the overlay receive module receiving, from an image overlay server, an overlay image;
an image receive module, the image receive module receiving, from the camera, a reality image;
a presentation image create module, the presentation image create module creating, based on the overlay image and the reality image, a presentation image; and
a display module, displaying the presentation image on the display.

2. The apparatus of claim 1, wherein the overlay image received further comprises data to create a three-dimensional rendering of the overlay image.

3. The apparatus of claim 2, wherein the non-transitory storage medium further comprises a location identify module, the location identify module calculating the location of the apparatus for presenting augmented reality in relation to a number of points in the reality image.

4. The apparatus of claim 3, wherein the presentation image create module creates the presentation image using the overlay image, the location of the apparatus, and the reality image to create an appearance that the overlay image is a three-dimensional image.

5. The apparatus of claim 1, wherein the non-transitory storage medium further comprises a radio frequency identification reader, the radio frequency identification reader informing the apparatus of an associated image overlay.

6. The apparatus of claim 1, wherein the device identify module verifies access permission by contacting a system for creating an augmented reality image.

7. A system for creating an augmented reality image, the system comprising:
a processor;
a network interface connector, communicatively connected to the processor; and
a non-transitory storage medium, the non-transitory storage medium comprising:
a first receive module, receiving, from a first user device, a number of images;
a customization module, the customization module allowing a first user to provide customization data for an overlay image;
an overlay create module, the overlay create module creating the image overlay to be displayed with a reality image;
a device identify module, the device identify module identifying an augmented reality apparatus, the augmented reality apparatus is an apparatus for presenting augmented reality;
an overlay transmit module, the overlay transmit module transmitting an overlay image to the augmented reality apparatus.

8. The system of claim 7, further comprising a second receive module, the second receive module receiving, from a second user device, a second number of images to be used in generating the overlay image.

9. The system of claim 7, wherein the customization module further comprises creating a three dimensional rendering of a figure for the overlay image.

10. The system of claim 7, wherein the customization module further comprises selecting a theme, the theme comprising a number of images to use in creating the overlay image.

11. The system of claim 7, wherein the device identify module uses one of a media access control address, an international mobile equipment identity, and a processor serial number from the augmented reality apparatus.

12. The system of claim 8, wherein the device identify module generates a unique key representing the second user device.

13. The system of claim 7, wherein the device identify module identifies a specified number of devices to be identified, the specified number of devices limiting the number of devices that may view the overlay image.

14. The system of claim 7, wherein the overlay transmit module transmits the overlay image a specified number of times, the specified number of times limiting the number of times the overlay image may be viewed.

15. A method for presenting augmented reality using an apparatus for presenting augmented reality, the method comprising:
identifying a token representing the apparatus for presenting augmented reality;
receiving, from an image overlay server, an overlay image data;
receiving, from a camera associated with an augmented reality apparatus, a reality image;
identifying, in the reality image, a number of reference points, the reference points informing the presentation of a presentation image;
creating, based on the overlay image data, the number of reference points, and the reality image, a presentation image; and
displaying the presentation image on a display.

16. The method of claim 15, wherein the overlay image data represents a three dimensional overlay image.

17. The method of claim 15, further comprising calculating, based on the number of reference points, a first location of the apparatus for presenting augmented reality.

18. The method of claim 15, further generating, based on the presentation image, a number of memorabilia images.

19. The method of claim 15, further comprising storing, on a non-transitory storage medium, the overlay image data.
